(19) United States
(12) Patent Application Publication
(10) Pub. No.: US 2015/0010200 A1
(43) Pub. Date: Jan. 8, 2015

(54) MEASURING APPARATUS AND MEASURING PROGRAM

(71) Applicant: KABUSHIKI KAISHA TOSHIBA, Tokyo (JP)

(72) Inventors: Tomokazu Kawahara, Yokohama-shi (JP); Yuki Hanyu, Kawasaki-shi (JP); Mitsuru Kakimoto, Kawasaki-shi (JP); Minoru Yonezawa, Tokyo-to (JP); Hideki Kobayashi, Yokohama-shi (JP)

(21) Appl. No.: 14/298,032

(22) Filed: Jun. 6, 2014

(30) Foreign Application Priority Data
Jul. 2, 2013 (JP) 2013-139009

(51) Int. Cl. G06T 7/00; G01W 1/02

(52) U.S. Cl. CPC G06T 7/00; G01W 1/02
USPC 382/100

(57) ABSTRACT

An apparatus includes: an acquiring unit configured to acquire a measured image including a cloud and a reference article; a specifying unit configured to specify a first area of the reference article in the measured image; a determining unit configured to determine whether or not the cloud exists on the near side of the reference article in the measured image; a position estimating unit configured to estimate the position of the cloud, if the cloud exists on the near side of the reference article, from a second area of the cloud in the measured image and the height and position of the reference article acquired from the information storage unit; an attenuation rate calculating unit configured to calculate a first luminance, which is a luminance of the second area of the measured image, and a second luminance, which is a luminance of the corresponding second area for the reference image acquired from the image storage unit, and calculating the attenuating rate of light from the first luminance and the second luminance; a density calculating unit configured to calculate a cloud density from the attenuation rate and the position of the cloud; and an output unit configured to output the position of the cloud and the cloud density.

### CROSS-REFERENCE TO RELATED APPLICATIONS

This application is based upon and claims the benefit of priority from the prior Japanese Patent Application No. 2013-139009, filed on Jul. 2, 2013; the entire contents of which are incorporated herein by reference.

### FIELD

Embodiments of the present invention relate to a measuring apparatus and a measuring program.

### BACKGROUND

In a weather forecast, the positions of clouds are one of important items of information, and a technology of shooting a first image and a second image by using two whole-sky cameras installed on the ground and calculating the positions of clouds by using these two images is proposed in the related art.

However, in the above-described technology, not only two whole-sky cameras are required for estimating the positions of clouds, but also the distance between the two whole-sky cameras needs to be increased for obtaining a sufficient field of view for the clouds. Therefore, a problem of increase in range of installation arises. There is another problem that the cloud density cannot be measured with this technology.

In view of such problems, it is an object of the present invention to provide a measuring apparatus and a measuring program that enable easy measurement of the positions of clouds and the cloud density.

### BRIEF DESCRIPTION OF THE DRAWINGS

FIG. 1 is a block diagram of a measuring apparatus of an embodiment;

FIG. 2 is a correspondence drawing illustrating a positional relationship among a camera, a mountain, and a cloud;

FIG. 3 is a measured image showing a mountain and a cloud;

FIG. 4 is a reference image showing a mountain in a clear sky with no cloud;

FIG. 5 is a flowchart illustrating an operating state of the measuring apparatus;

FIG. 6 is a measured image showing a building and a cloud;

FIG. 7 is a measured image showing an aircraft and a cloud;

FIG. 8 is a measured image showing a balloon and a cloud; and

FIG. 9 is a block diagram illustrating an example of a hardware configuration of the measuring apparatus.

### DETAILED DESCRIPTION

According to embodiments, a measuring apparatus of the embodiment disclosed here includes: an information storage unit configured to store a height and a position of a reference article; an image storage unit configured to store a reference image showing the reference article in a state having no cloud therearound; an acquiring unit configured to acquire a measured image including a cloud and the reference article; a specifying unit configured to specify a first area of the reference article in the measured image; a determining unit configured to determine whether or not the cloud exists on the near side of the reference article in the measured image; a position estimating unit configured to estimate the position of the cloud, if the cloud exists on the near side of the reference article, from a second area of the cloud in the measured image and the height and position of the reference article acquired from the information storage unit; an attenuation rate calculating unit configured to calculate a first luminance, which is a luminance of the second area of the measured image, and a second luminance, which is a luminance of the corresponding second area for the reference image acquired from the image storage unit, and calculating the attenuating rate of light from the first luminance and the second luminance;

a density calculating unit configured to calculate a cloud density from the attenuation rate and the position of the cloud; and an output unit configured to output the position of the cloud and the cloud density.

Referring now to FIG. 1 to FIG. 9, a measuring apparatus 1 of an embodiment will be described.

The measuring apparatus 1 is configured to measure the positions of clouds and the cloud densities. Here, the term “cloud” means a mass of millions of water droplets or ice crystals floating in the air, and the term “cloud density” means the weight (kg) of water per 1 kg of atmospheric air (non-dimensional unit), the weight of water droplets or ice (unit: kg/m³), or the number of crystals (unit:/m³) per unit volume.

Referring now to FIG. 1, a configuration of the measuring apparatus 1 will be described. FIG. 1 is a block diagram illustrating the measuring apparatus 1. As illustrated in FIG. 1, the measuring apparatus 1 includes a camera 10, an acquiring unit 12, a specifying unit 14, a determining unit 16, a position estimating unit 18, an attenuation rate calculating unit 20, a density calculating unit 22, an output unit 24, an information storage unit 26, and an image storage unit 28.

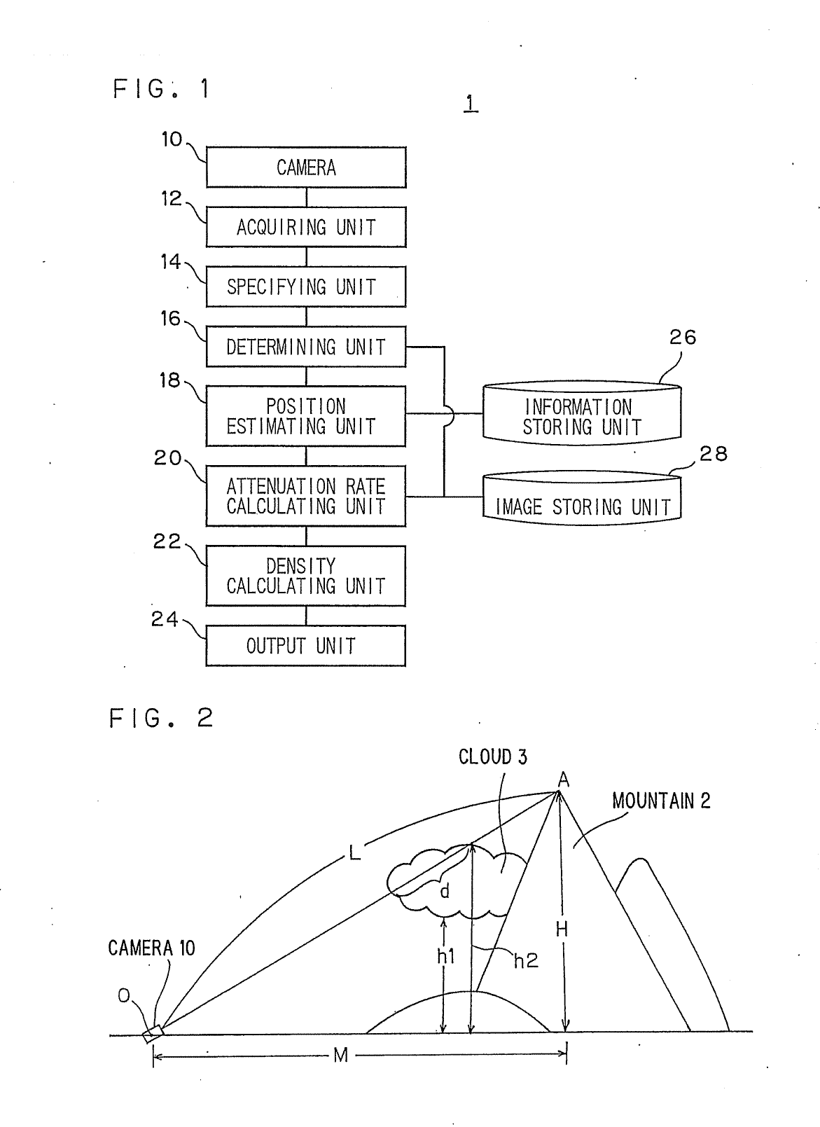

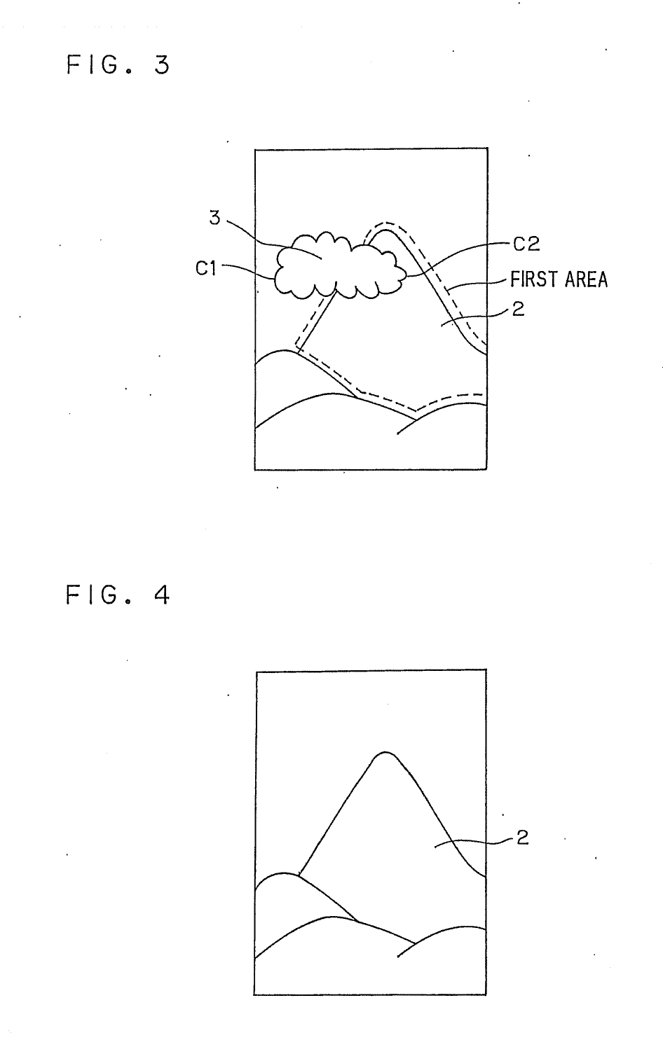

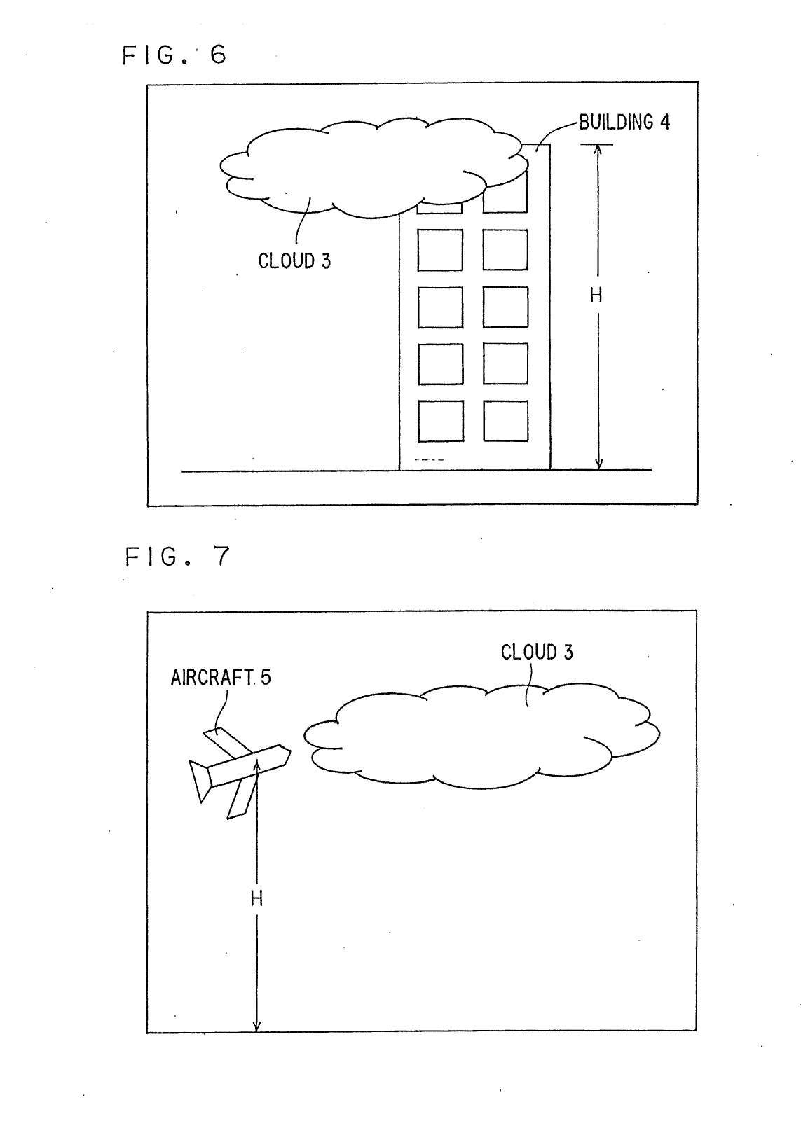

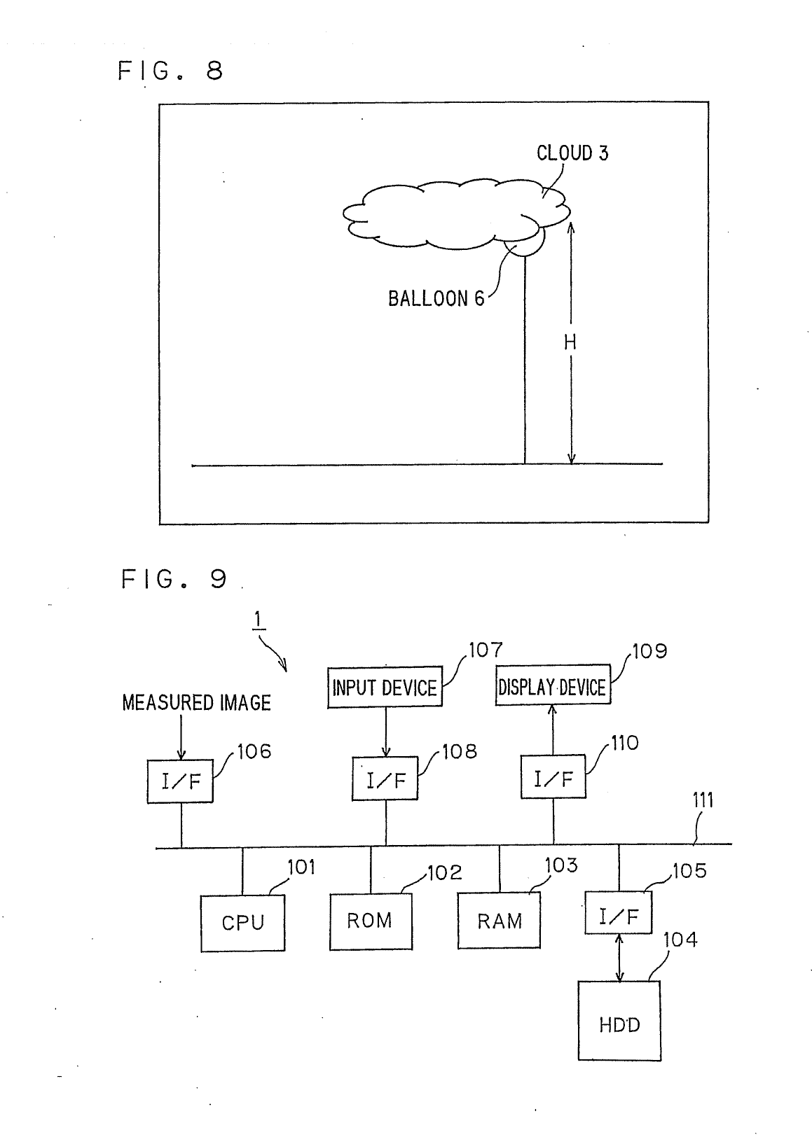

The camera 10 is provided singularly as illustrated in FIG. 2, and shoots a measured image by using a CCD element. As illustrated in FIG. 3, the camera 10 is fixed to a shooting position O so that a reference article (for example, a mountain, a hill, a building, a tower, a flying aircraft, or a floating balloon) having a known height is included in the measured image. The shooting position O is specified in position in advance by a GPS. In the following description, a mountain 2 is used as the reference article as illustrated in FIG. 2. For reference of the measured image, FIG. 6 illustrates a case where a building 4 is shot as the reference article, and FIG. 7 illustrates a case where an aircraft 5 is shot as the reference article, and FIG. 8 illustrates a case where a balloon 6 is shot as the reference article.

The acquiring unit 12 acquires the measured image illustrated in FIG. 3 via a wireless line or a wired line from the camera 10. The acquiring unit 12 may be integrated with the camera 10.

The specifying unit 14 specifies a first area of a reference article displayed in the measured image (see area surrounded by a dot line in FIG. 3). Hereinafter the first area is called a display area. Since the mountain 2 is shown in the measured image as the reference article, the display area in which the mountain 2 is displayed is specified by pixel positions or the like. Examples of the method of specifying the display area are given below.

In a first method, a user specifies the display area manually.

In a second method, an image only of the reference article in a clear sky with no cloud is shot in advance, and an area other than the sky is specified as the display area for the reference article from the luminance or the color in the shot image. The image of the mountain 2 in the clear sky with no cloud is acquired from an image storage unit 28, which will be described below. Here, the clear sky “with no cloud” corresponds to an image of the mountain with no cloud to be referenced.

In a third method, a condition that a reference article is shot at a center portion of the measured image is provided, and an area of a predetermined range from the center of the measured image is specified as the display area of the reference article.

The determining unit 16 determines whether or not the cloud 3 exists on the near side of the mountain 2 on the measured image. A determining method will be described.

First of all, the determining unit 16 calls an image shot at the same shooting position at which the measured image is shot by the camera 10 at the same time when the position of the sun in the celestial sphere is the same (hereinafter, referred to as “reference image”, see FIG. 4) from the image storage unit 28.

Subsequently, the determining unit 16 compares the reference image showing a clear sky with no cloud illustrated in FIG. 4 and a measured image illustrated in FIG. 3, and determines white, gray, and black areas, which are shown on the near side of the reference article in the measured image but are not shown in the reference image, as a cloud area (a second area) of the cloud 3 in the measured image.

The image storage unit 28 stores reference articles in the clear sky with no cloud by shooting position (the shooting direction if needed), month, day, and time of the day. When the determining unit 16 acquires the reference image from the image storage unit 28, the shooting position (the shooting direction, if needed) of the camera 10, the shooting month and day are to be specified. The image storage unit 28 outputs the reference image corresponding to the specified shooting position and shooting month and day to the determining unit 16. When the determining unit 16 compares the reference image and the measured image, the shooting positions (or the shooting direction) need to match. However, items such as the shooting time and the shooting month and day do not have to match completely. If the position of the sun is the same, the light amount and the shadowing are also the same, so that the shooting time may be shifted by, for example, approximately 30 minutes and the shooting day may be shifted, for example, by approximately 10 days.

Subsequently, a method that the position estimating unit 18 estimates the position of the cloud 3 will be described. In the information storage unit 26, the height H and the position (for example, information on latitude and longitude of a mountain top A) of the reference article are stored.

First of all, the position estimating unit 18 acquires the height H and the position of the mountain top A of the reference article (mountain 2) shown in the measured image from the information storage unit 26.

Subsequently, the position estimating unit 18 calculates a cloud bottom height h1 and a cloud top height h2 in the cloud area specified by the determining unit 16 by using the height H of the reference article (the height of the mountain 2). For example, since the reference article is the mountain 2, if 20% of the mountain 2 from the top is covered with the cloud 3, the cloud bottom height h1 corresponds to 0.8 times the height H of the mountain 2.

Subsequently, the position estimating unit 18 calculates a left end C1 and a right end C2 of the cloud area, and the distance between the left end C1 and the right end C2 with reference to the height H of the mountain 2 and the position of the mountain top A.

In the following description, the position of the cloud 3 includes the cloud bottom height h1, the cloud top height h2, the positions of the left end C1 and the right end C2 of the cloud area, and the distance between the left end C1 and the right end C2. However, when all items of the information cannot be estimated as in the case where the left end C1 of the cloud area is not shown in the measured image or the whole sky is covered with the cloud 3, items of the information which cannot be estimated are flagged as “incapable of measurement”.

The attenuation rate calculating unit 20 compares the reference image and the measured image shot at the same time of day on the same day stored in the image storage unit 28, and calculates an attenuation rate in the cloud area.

In other words, in the reference image, it is assumed that there is no attenuation of light by the cloud 3 in the reference image, and how much attenuation of light is achieved by the cloud 3 is estimated in the measured image. Therefore, a measured luminance (a first luminance) I1 of the cloud area of the measured image and a reference luminance (a second luminance) 10 of an area in the reference image, which corresponds to the cloud area in the measured image are obtained respectively, and the attenuation rate G=I1/I0 is calculated.

An average value of luminance of a plurality of pixels included in the cloud area is used as the measured luminance I1 of the measured image. The same applies to the reference luminance I0. The highest luminance or the lowest luminance of the cloud area of the measured image may be used as the measured luminance I1.

The density calculating unit 22 calculates a cloud density x on the basis of the attenuation rate G (the ratio between the reference luminance I0 and the measured luminance I1) and the thickness d of the cloud 3.

According to the “Contrast Restoration of Weather Degraded Images”, Srinivasa G. Narasimhan and Shree K. Nayar. IEEE Transaction on Pattern Analysis and Machine Intelligence, Vol. 25, No. 6, June 2003, the reference luminance I0, the measured luminance I1, and the thickness d of the cloud 3 have a relationship as an expression (1) given below.

I1={I0×exp(−x×d)}/d² (1)

### Therefore,

$$x = \{ log ( {d}^{2} \times I 1 / I 0 ) \} / d = \{ log ( {d}^{2} / G ) \} / d \qquad ( 2 )$$

However, since the thickness d of the cloud 3 cannot be observed directly, the density calculating unit 22 calculates by performing a pattern recognition as described below.

First of all, the density calculating unit 22 stores templates indicating the shapes of the cloud and normalized thickness of clouds by a variety of templates of the clouds in accordance with the types of the clouds (cirrus cloud, cirrocumulus cloud, cirrostratus cloud, altocumulus cloud, altostratus cloud, nimbostratus, stratocumulus, cumulus cloud, and cumulonimbus cloud).

The term “thickness” here means the thickness of the cloud when the distance between the left end C1 and the right end C2 of the cloud has a predetermined length. For example, when creating data of these templates, if the type of the observed cloud is cumulus cloud, the distance between the left end C1 and the right end C2 is 20 km and the thickness is 10 km, the distance is converted into 10 km and the normalized thickness is stored as 5 km. The reason why the thickness of the cloud is normalized is because the clouds 3 have different sizes even though the type is the same.

Subsequently, the density calculating unit 22 performs the pattern recognition by applying the templates on the basis of the types of the cloud to the cloud area in the measured image in sequence, selects a type of the cloud having a highest similarity, and calls the thickness of the cloud corresponding to the type of the cloud in question. Here, since the thickness of the cloud is normalized as described above, the distance between the left end C1 and the right end C2 of the measured cloud 3 is converted into an actual thickness d. Data calculated by the position estimating unit 18 is used as the distance between the left end C1 and the right end C2 of the cloud area.

It is also possible to store a cloud bottom height of the cloud of the type in question, compare the cloud bottom height with the cloud bottom height h1 of the cloud 3 obtained by the position estimating unit 18, and eliminate templates of the types the heights of the cloud of which are too much different from the pattern recognition. For example, if the cloud bottom height h1 is approximately 2 km, the templates of altostratus cloud, such as the cirrus cloud, the cirrocumulus cloud, and cirrostratus cloud may be eliminated.

The density calculating unit 22 obtains the thickness d of the cloud as described above, then plug in the thickness d and the attenuation rate G in the expression (2), thereby calculating the cloud density x.

The output unit 24 outputs the cloud density x estimated by the density calculating unit 22 and the position of the cloud 3 estimated by the position estimating unit 18 to a weather forecast system or the like.

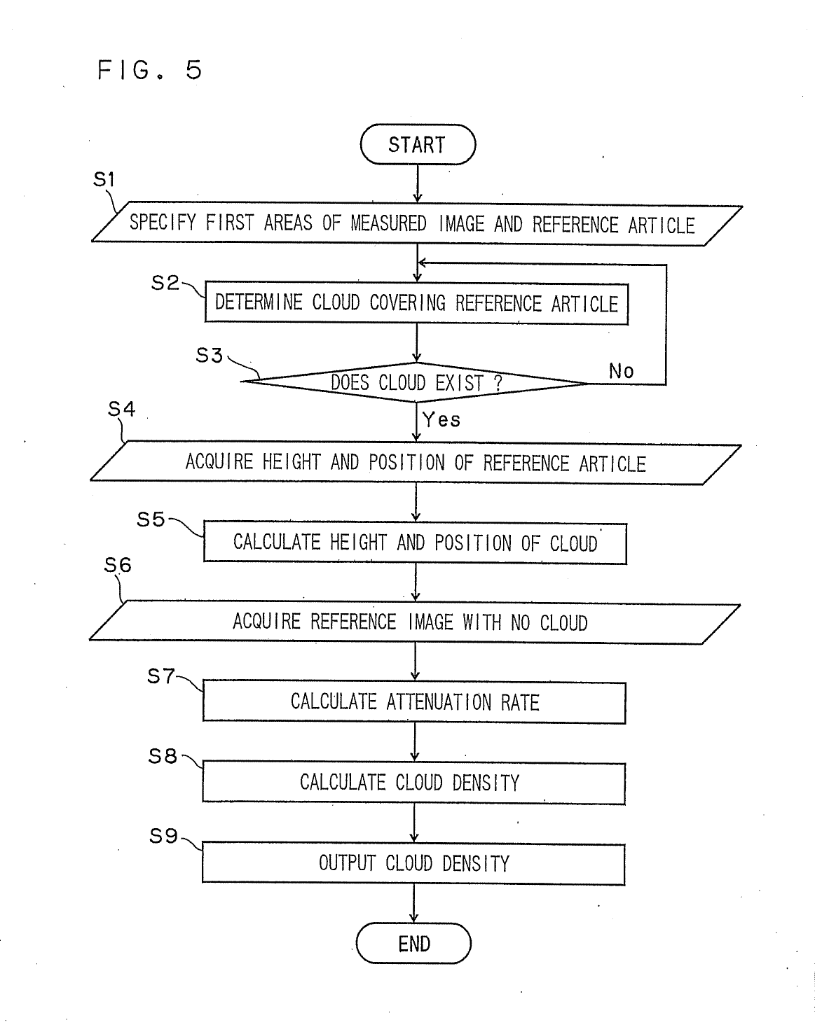

An operating state of the measuring apparatus 1 will be described on the basis of a flowchart in FIG. 5.

In Step S1, the camera 10 shoots a measured image, and the acquiring unit 12 acquires a measured image illustrated in FIG. 3. Then, the specifying unit 14 specifies a display area of a reference article (mountain 2) in the acquired measured image, and the procedure goes to Step S2.

In Step S2, the determining unit 16 determines whether or not the cloud 3 exists on the near side of the display area of the mountain 2 specified by the specifying unit 14 and, if the cloud 3 does not exist, the procedure goes back to Step S2, and if the cloud 3 exists, the cloud area in the measured image is specified, and the procedure goes to Step S4.

In Step S4, the position estimating unit 18 acquires the height H and the position of the mountain 2 form the information storage unit 26, and the procedure goes to Step S5.

In Step S5, the position estimating unit 18 estimates the position of the cloud 3 including the height of the cloud 3 (the cloud bottom height h1 and the cloud top height h2) on the basis of the height H of the mountain 2, and the procedure goes to Step S5.

In Step S6, the attenuation rate calculating unit 20 acquires a reference image with the clear sky with no cloud illustrated in FIG. 4 from the image storage unit 28, and the procedure goes to Step S7.

In Step S7, the attenuation rate calculating unit 20 calculates the measured luminance I1 of the measured image in the cloud area and the reference luminance I0 of the reference image of the clear sky with no cloud, then calculates the attenuation rate G of light, and the procedure goes to Step S8.

In Step S8, a template is applied to obtain the thickness d of the cloud 3 for the cloud 3 shot by the density calculating unit 22. Subsequently, the density calculating unit 22 uses the thickness d and the attenuation rate G of the cloud 3 to calculate the cloud density x from the expression (2), and the procedure goes to Step S9.

In Step S9, the output unit 24 outputs the position and the cloud density x of the cloud 3 and terminates.

From the procedure described above, according to the measuring apparatus 1 of the embodiment disclosed here, the position and the cloud density x of the cloud 3 can be measured only by shooting the cloud 3 located on the near side of the reference article by a single camera.

Only by shooting the measured image by the camera 10, which is not a specific instrument of observation such as those used by Meteorological Agency or private meteorological companies, the cloud density x in the periphery may be measured.

Although the weather situations in respective regions are observed by AMeDAS in addition to a weather station of meteorological observatory of Meteorological Agency, local meteorological stations, and weather radars, weather that the users expect cannot be estimated with these observation networks. Therefore, by fixing the camera 10 at a position desired by the user and measuring the cloud density x or the positions of clouds in the periphery as in the embodiment disclosed here, the weather at the position where the camera 10 is fixed can be forecasted accurately.

A modification in which the density calculating unit 22 calculates the thickness d of the cloud 3 will be described with reference to FIG. 2.

The density calculating unit 22 acquires the cloud bottom height h1 and the cloud top height h2 acquired by the position estimating unit 18.

Subsequently, the density calculating unit 22 obtains a distance M to the camera 10 and the mountain 2. The distance M is calculated from the GPS information of the position O of the camera 10 and the position of the mountain 2 (obtains the latitude and the longitude of the position of the mountain top A from a map).

Subsequently, the density calculating unit 22 obtains a direct distance L to the camera 10 and the mountain top A. The direct distance L is determined by the expression (3).

L=√(H²+M²) (3)

Then, the following expression (4) is established.

L:d=H:(h2−h1) (4)

Therefore, the density calculating unit 22 can calculate the thickness d of the cloud from the expression (5).

d=(h2−h1)×L/H (5)

In the case where the cloud top cannot be viewed due to the whole sky is covered, h2=H is established. Additional information “h2 H” (if the flag is 0, the result is as calculated and if the flag is 1, the result is equal to or larger than calculated value) may be added.

FIG. 9 is a block diagram illustrating an example of a hardware configuration of the measuring apparatus 1. As illustrated in FIG. 9, the measuring apparatus 1 includes a CPU 101, a ROM 102, a RAM 103, the information storage unit 26, a HDD 104 corresponding to the image storage unit 28, an I/F 105 as an interface with respect to the HDD 104, an I/F 106, which is an interface for inputting the measured image from the camera 10, an input device 107 such as a mouse or a keyboard, an I/F 108, which is an interface with respect to the input device 107, a display device 109 such as a display, an I/F 110, which is an interface with the display device 109, and a bus 111, and has a hardware configuration using a general computer. The CPU 101, the ROM 102, the RAM 103, the I/F 105, the I/F 106, the I/F 116, and the I/F 110 are connected to each other via the bus 111.

In the measuring apparatus 1, the CPU 101 reads the program from the ROM 102 on the RAM 103 and executes, whereby the above-described members (the acquiring unit 12, the specifying unit 14, the determining unit 16, the position estimating unit 18, the attenuation rate calculating unit 20, the density calculating unit 22, and the output unit 24) are realized on the computer, and performs the above-described process from the I/F 106 by using data or the like of the information storage unit 26 and the image storage unit 28 stored in the HDD 104.

The calculating program may be stored in the HDD 104. The calculating program may be provided by being stored in a computer-readable memory medium such as CD-ROMs, CD-Rs, a memory cards, DVD, flexible disks (FD), or USE memories having an installable format or an executable format. The program may be provided by storing in a computer connected to the network such as internet and downloading the same via a network. The measuring program may be provided or distributed via the network such as an internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A measuring apparatus comprising
an information storage unit configured to store a height and a position of a reference article;
an image storage unit configured to store a reference image showing the reference article in a state having no cloud therearound;
an acquiring unit configured to acquire a measured image including a cloud and the reference article;
a specifying unit configured to specify a first area of the reference article in the measured image;
a determining unit configured to determine whether or not the cloud exists on the near side of the reference article in the measured image;
a position estimating unit configured to estimate the position of the cloud, if the cloud exists on the near side of the reference article, from a second area of the cloud in the measured image and the height and position of the reference article acquired from the information storage unit;
an attenuation rate calculating unit configured to calculate a first luminance, which is a luminance of the second area of the measured image, and a second luminance, which is a luminance of the corresponding second area for the reference image acquired from the image storage unit, and calculating the attenuating rate of light from the first luminance and the second luminance;
a density calculating unit configured to calculate a cloud density from the attenuation rate and the position of the cloud; and
an output unit configured to output the position of the cloud and the cloud density.

2. The apparatus according to claim 1, wherein the density calculating unit calculates the cloud density from the attenuation rate and the thickness of the cloud obtained from the position of the cloud.

3. The apparatus according to claim 2, wherein the density calculating unit calculates the thickness of the cloud by performing pattern recognition by applying a plurality of types of templates corresponding to the types of the cloud stored in advance to the second area in the measured image.

4. The apparatus according to claim 2, wherein the density calculating unit calculates the thickness of the cloud from a shooting position of the measured image, the height of the reference article, and the height of the cloud included in the position of the cloud.

5. The apparatus according to claim 1, wherein the reference article is a mountain, a hill, a building, or a flying object.

6. A computer program product comprising a computer-readable medium containing a computer program, wherein the computer program, when executed by a computer, causes the computer to perform:
storing the height and the position of a reference article;
storing a reference image showing the reference article in a state of the clear sky with no cloud;
acquiring a measured image including a cloud and the reference article;
specifying a first area of the reference article in the measured image;
determining whether or not the cloud exists on the near side of the reference article;
estimating the position of the cloud, if the cloud exists on the near side of the reference article, from a second area of the cloud in the measured image and the height and position of the reference article acquired from the information storage unit;
calculating a measured luminance, which is a luminance of the second area in the measured image, and a reference luminance, which is a luminance of the corresponding second area for the reference image acquired from the image storage unit, and calculating the attenuation rate of light from the first luminance and the second luminance;
calculating a cloud density from the attenuation rate and the position of the cloud; and
outputting the position of the cloud and the cloud density.
